(19) United States
(12) Patent Application Publication
(10) Pub. No.: US 2004/0006424 A1
(43) Pub. Date: Jan. 8, 2004

(54) Control system for tracking and targeting multiple autonomous objects

(76) Inventors: Glenn J. Joyce, Nashua, NH (US); Brian Tarbox, Littleton, MA (US)

Correspondence Address: MAINE & ASMUS, 100 MAIN STREET, P O BOX 3445, NASHUA, NH, 03061-3445, US

(21) Appl. No.: 10/610,202

(22) Filed: Jun. 30, 2003

Related U.S. Application Data
(60) Provisional application No. 60/392,947, filed on Jun. 28, 2002.

(51) Int. Cl. G01C 21/26

(52) U.S. Cl. 701/207; 342/357.07

(57) ABSTRACT

A control system for dynamically tracking and targeting multiple targets wherein the targets have position sensors and communicate to with central location that uses the information to process projected locations of moving targets. The system uses several means to smooth the track and to deal with missing or degraded data, wherein the data may be degraded in either time or location. The present system can use a combination of Kalman filtering algorithms, multiple layers of smoothing, decoupled recording of predicated positions and use of those predications along with optimization of speed of apparent target motion to achieve a degree of time on target.

### RELATED APPLICATIONS

This application claims the benefit of U.S. Provisional Application No. 60/392,947, filed Jun. 28, 2002, which is herein incorporated in its entirety by reference.

### FIELD OF THE INVENTION

The present invention relates to target tracking, and more particularly to utilizing global positioning systems (GPS) and other radio position measurement devices in conjunction with position-oriented devices to dynamically track moving targets.

### BACKGROUND OF THE INVENTION

The entertainment and enjoyment from viewing spectator sports is universal, and it is a common occurrence for people everywhere to gather around a television to watch a particular team or sporting event. Sports such as baseball, basketball, football, racing, golf, soccer and hockey are viewed by millions every week. Certain events such as the Super Bowl, World Series, and the Olympics have an enormous numbers of viewers. At any given time, live coverage of multiple sports is available via cable or satellite, while the big networks generally have exclusive coverage of certain sporting events. Even those that attend the actual event employ televisions as a means to elicit further information and view the event from a different perspective.

The television sports media is an enormous revenue generator with paid advertising running millions of dollars for a single minute during certain events. Due to the profitability of the service, the coverage of these events is a complex orchestration involving multiple cameras and crews. In order to ensure continued and increased viewership, the media must generate high quality programs. Many of the events incorporate computerized systems and complex electronics to enable panoramic viewing, slow motion, and multi-angle shots.

Of all spectator sports in the United States, it is generally considered that automobile racing is the most widely viewed. However, car racing has certain properties that make televising difficult, namely that the multiple cars are traveling at times over 200 miles per hour. Other sports with multiple moving targets or fast moving targets have similar problems that the industry has attempted to resolve. Television viewers are not pleased when they miss an important aspect of the game and if another provider has better service, the viewers will switch.

In addition, one of the problems with multiple target events such as car racing or horse racing is that the television tends to track the leader. There may be significant events occurring amongst the other targets that are missed. In addition, viewers may have personal favorites that may not be in-camera for any significant time if they are not leading.

With the just-described motivation in mind, a system has been conceived which allows the multiple, independent targets to report instantaneous position information to a computing device over a wireless communications medium. The computing device applies algorithms to each target's position to augment a kinematical state model for each target. Further, the computing device generates commands to drive direction-sensitive devices, such as cameras, microphones and antennae, to accurately track specific targets as they move through the area of interest.

Equations of Motion describe how the kinematical state of each object is modeled. The basis for the equations of motion is presented and that is followed by a description of how the raw data is processed by the Kalman filter so as to provide optimal data for the model given the error term for the measurement device. At any discrete moment in time, an object has a position in three-dimensional space. The modeled kinematical state of each object allows an accurate projection of future object positions.

An object that exists in a one-dimensional system has a position X at time t. For simplicity, the notation Xₜ will be used to express this concept. In order to provide an ordinal dimension to the variable t, the subscript “0”, “1”, “2” . . . “n” will be used. Further, an object's initial position may be expressed as position X at time t₀.

If the object is stationary, its position at time t₁ may be expressed in terms of the object's position at time t₀ via the equation:

Xₜ_{₁}=Xₜ_{₀}

If the object remains stationary forever, it's position at any time can be expressed as:

Xₜ_{ₙ}=Xₜ_{₍ₙ₋₁₎}

If the same object is in motion, the object is said to have velocity (v). Velocity is change in position X over a period of time. This may be written as:

$$\frac{ⅆ x}{ⅆ t} = v$$

where dx may be read as “change in position X” and dt may be read as “change in time t”. The above equation may be rewritten as:

dx=νdt

This equation states “change in position X is equal to velocity multiplied by the time interval”. If the object changes location from one moment to another, the object has velocity. Velocity is also recognized as the first derivative of position with respect to time. For simplicity of notation, velocity, the first derivative of position may also be written as X′.

In order to calculate the total change in position due to an object's velocity over an interval of time, an integral with respect to time is performed:

∫dx=∫νdt

When the integral is evaluated, the result is:

x=νt

Position change due to velocity=vt

In the case of steady-state motion, the position calculation equation becomes:

Xₜ_{₁}=Xₜ_{₀}+νt

The object is at rest if the change in velocity from one time interval to another time interval is zero. If the difference in velocity between the two time intervals is not zero, the object is said to have acceleration. The equations of motion may be expanded to include acceleration (a), wherein acceleration is defined to be a change in velocity over a period of time. Acceleration may be expressed as:

$$\frac{ⅆ v}{ⅆ t} = a$$

Rewriting the equation yields:

dν=adt

Integrating both sides of the previous equation yields the result:

∫dν=∫adt

ν=at

This equation demonstrates that velocity is equal to acceleration multiplied by a time interval.

Finally, integrating velocity over time yields change in position:

∫νdt=∫atdt

$$vt = \frac{1}{2} a {t}^{2}$$

Thus, acceleration is change in velocity over an interval of time. Acceleration is recognized as the second derivative of position with respect to time. Positive acceleration describes an object whose velocity increases over time; negative acceleration means that the velocity of the object is decreasing over time. For simplicity of notation, acceleration, the second derivative of position, may also be written as X″.

If the magnitude of acceleration that an object experiences over a period of time is zero, the object has constant acceleration. If the magnitude of an object's acceleration differs between two time intervals, the object has jerk. Jerk is recognized as the third derivative of position with respect to time. Positive jerk describes an object whose acceleration increases in magnitude. Conversely, objects that experience a decrease in acceleration experience negative jerk.

From earlier, we saw that x=νt. Therefore we can make a substitution in the previous equation:

$$x = \frac{1}{2} a {t}^{2}$$

$$Position change due to acceleration = \frac{1}{2} {at}^{2}$$

Since a high degree of fidelity in the model of motion is desired, the jerk (j) is also modeled. It is important to note that in a system that models autonomous objects, the objects may change acceleration. Therefore, it is crucial that the equations of motion for the system include a term that models the change in acceleration. The jerk may be written as:

$$\frac{ⅆ a}{ⅆ t} = j$$

Employing the same technique employed earlier to rewrite the equation produces:

da=jdt

Integrating the change in jerk over time yields the jerk term's affect on acceleration:

∫da=∫jdt

a=jt

Substituting for a, yields:

$$\frac{v}{t} = t$$

Which can be further refined to be:

ν=jt²

Finally, integrating velocity with respect to time yields the jerk's contribution to change in position over the time period:

∫νdt=∫jt²dt

$$Position change due to jerk = \frac{1}{3} {j}^{3} t$$

Jerk is also recognized as the third derivative of position with respect to time. For simplicity of notation, the third derivative of position may also be written as X′″.

When all of the terms from the above equations are assembled, it results in the following equation for the change in position between tₙ and tₙ₊₁:

$$\begin{matrix}{X}_{{t}_{n + 1}} = {X}_{{t}_{n}} + {X}_{{t}_{n}}^{′} ( {t}_{( n + 1 )} - {t}_{n} ) + \frac{1}{2} {{X}_{{t}_{n}}^{″} ( {t}_{( n + 1 )} - {t}_{n} )}^{2} + \\ \frac{1}{3} {{X}_{tn}^{′′′} ( {t}_{( n + 1 )} - {t}_{n} )}^{3}\end{matrix}$$

Objects in the system exist in a three-dimensional space. By convention, the positions will be described as a tupple of the form (X, Y, Z). The values in the tupple correspond to the object's position the coordinate system. At a time tₙ, an object will have a position (Xₜ_{ₙ}, Yₜ_{ₙ}, Zₜ_{ₙ}). At subsequent time tₙ₊₁, the object will have a position (Xₜ_{ₙ₊₁}, Yₜ_{ₙ₊₁}, Zₜ_{ₙ₊₁}).

The kinematical equations for the system's three dimensions therefore are:

$$\begin{matrix}{X}_{{t}_{n}} = {X}_{{t}_{n - 1}} + {X}_{{t}_{n - 1}}^{′} t + \frac{1}{2} {X}_{{t}_{n - 1}}^{″} {t}^{2} + \frac{1}{3} {X}_{{t}_{n - 1}}^{′′′} {t}^{3} \\ {Y}_{{t}_{n}} = {Y}_{{t}_{n - 1}} + {Y}_{{t}_{n - 1}}^{′} t + \frac{1}{2} {Y}_{{t}_{n - 1}}^{″} {t}^{2} + \frac{1}{3} {Y}_{{t}_{n - 1}}^{′′′} {t}^{3} \\ {Z}_{{t}_{n}} = {Z}_{{t}_{n - 1}} + {Z}_{{t}_{n - 1}}^{′} t + \frac{1}{2} {Z}_{{t}_{n - 1}}^{″} {t}^{2} + \frac{1}{3} {Z}_{{t}_{n - 1}}^{′′′} {t}^{3}\end{matrix}$$

As the kinematical state for each tracked object is maintained, present values for position, velocity, acceleration and jerk for each object may be calculated and projected forward in time by the use of different values of t. Due to the uncertainty of the true values for each of the modeled quantities, the projections are of limited value for a short interval into the future (e.g. they are likely to be valid for seconds rather than minutes).

An Inertial Frame of Reference is a setting in which spatial relations are Euclidian and there exists a universal time such that space is homogenous and isotropic and time is homogenous. Every object in the disclosed system has a frame of reference. Within the frame of reference, an object's measurable characteristics, such as position, velocity, acceleration, jerk, roll, pitch and yaw may be observed. The measured values provide the definition of the observed kinematical state of an object.

An object's frame of reference may be modeled or simulated. Observed characteristics are combined algorithmically via a computing device to produce a modeled kinematical state. The modeled kinematical state may account for inaccuracies in values reported by measuring devices, perturbations in an object's behavior as well as any other conceived characteristic, anomalous or random behavior. Variables such as time may be introduced in to the modeled kinematical state to allow the model to project a likely kinematical state at a time in the future or past. It is this property of the system that facilitates the process of tracking.

The term tracking is defined to be knowledge of the state of an object combined with calculations that enable an observer to arrive at a solution that is valid in the observer's frame of reference that allows the observer to achieve a desired orientation toward or representation of the object.

An embodiment for achieving smooth tracking is the computation and use of apparent target speed rather than relative target position. A tracked object may appear to move more rapidly as it passes near to an observer rather than when it is far away from the observer. This phenomenon is known as geometrically induced acceleration or pseudo-acceleration. Optimization of the path that an observer must follow in order to track the target reflects the fact that a geometrically induced acceleration may be present even though the target may be undergoing no acceleration in its frame of reference. This embodiment provides a mechanism for observers to choose their own means of achieving optimal target tracking independent of any underlying assumptions about the target's dynamics in their own frame of reference.

The maximum pseudo-acceleration an observer would see while tracking a particular target is expressed by the equation:

$${a}_{max} = \frac{{v}^{2}}{{R}_{c}}$$

Where qₘₐₓ is the maximum pseudo-acceleration at the observer's position, ν is the absolute velocity of the target and R_{c} is the distance of the closest approach of the target to the observer.

Minimizing the solution to this equation provides the lowest achievable value for the jerk in the targeting solution.

An exemplar use of this capability is when optical sensors, such as television cameras mounted on robotic pointing platforms, track targets. It is highly desirable to control the rate of change of the motion of the robotic camera platform to produce a fluid pan, tilt, zoom and focus than it is to have a video image that jerks as the tracked object experiences actual and geometrically induced accelerations. Slight errors in positioning are more acceptable than jerky targeting. While high-speed automobile races, by definition, result in large position motions, the second derivative of target speed is usually much lower. By selecting the correct variable to optimize, the system achieves high degrees of smoothness.

Each position report received from the position reporting system is run through a calculation engine to convert it into a client-relative speed value. The client-relative speed value is not a target-based speed but rather the speed required to re-point the client platform at the new location of the target. An example of this would be a car accelerating down the straightaway of a racecourse. As the car moves and sends position reports, a client camera must calculate the speed at which it should rotate or pan in order to keep the target in frame. The rate of pan will change even if the target's absolute velocity is constant, because as the distance from the location of the client to the location of the target decreases, the target's velocity tangent to the client's location continually increases. The client can therefore employ a strategy of smoothing the change in pan acceleration, (e.g. jerk), in the commands it sends to pan the camera since it receives a set of predictions of where the target is expected to be. This a priori knowledge of where the target will probably be at a time in the future allows it to computationally accommodate for that by spreading out change in acceleration over a larger period of time. By changing the variable being calculated from the target position to the client rotation speed, the current system more closely models the way that a human camera operator works. If a sensor's field of view has overshot the actual target position neither a human operator nor the system jerks the sensor to reacquire the target. Both systems simply adjust the rate at which they rotate their field of view.

As described herein, all position measurement systems generate an estimate of where the object is at some future time. The estimate will differ from the object's true location by an error term. The magnitude of the error term will vary depending on the properties of each position measurement device. For this reason, data received from each position measurement device must be filtered so that it becomes an optimal estimate of the tracked object's position.

Raw data produced by a position measurement system may not be well correlated. This implies that the error term may be random over the measurement interval. As a result, if the position reports were taken and used directly without any sort of filter, then the result would be that the kinematical state would appear to jitter or move erratically.

Since some characteristics of the performance of the position measurement equipment is known (such as the position measurement error standard deviation), it is possible to mathematically optimize the data that is received from each object's position measurement devices so that when it used to drive the kinematical state equations, the result is an optimal position estimate. A Kalman filter is exactly such an optimal linear estimator and is described in further detail herein.

The ability to locate the position of an object in an accurate fashion is amply covered in the art, and covers multiple forms of implementation. A Global Navigation Satellite System (GNSS) is one form of radio navigation apparatus that provides the capability to make an instantaneous observation of an object's position from the object's frame of reference. Two examples of GNSS systems are the Navistar Global Positioning System (GPS) that is operated by the United States Air Force Space Command and the GLObal NAvigation Satellite System (GLONASS) operated by the Russian Space Forces, Ministry of Defense. Output from a GNSS receiver may be coupled with a communications mechanism to allow position reports for an autonomous object to be collected. The position reports allow a computing device to model the behavior of the autonomous object.

A radio navigation system relies on one or more radio transmitters at well-known locations and a radio receiver aboard the autonomous object. The radio receiver uses well-known information about the speed of propagation of radio waves in order to derive a range measurement between the receiver and the transmitter. Radio navigation receivers that can monitor more than one radio navigation transmitter can perform simultaneous range calculations and arrive at a computational geometric solution via triangulation. The radio navigation device then converts the measurement in to a format that represents a measurement in a coordinate system.

As is the case with any type of measurement device, the accuracy of an individual position measurement includes an error term. The error term reflects uncertainty, approximation, perturbations and constraints in the device's sensors, computations and environmental noise. Global Navigation Satellite System receivers are no different in this respect. The position measurements that they provide are a reasonable approximation of an object's true position. GNSS receivers produce measurements that include an error term. This means that any device or person that consumes data produced by a GNSS measurement device must be aware that the GNSS position reports are approximations and not absolute and true measurements.

GNSS systems employ a GNSS receiver at the location where the position report is to be calculated. The receiver is capable of tuning in the coded radio transmissions from many (typically up to 12) GNSS satellites at the same time. Each GNSS satellite contains an extremely high-precision timekeeping apparatus. The timekeeping apparatus of each GNSS satellite is kept synchronized with one another. Each GNSS satellite transmits the output from its timekeeping apparatus. When the radio signal for a specific GNSS satellite arrives at the receiver, it defines a sphere of radius R1. The GNSS receiver listens for the radio broadcast from a second GNSS satellite. Once acquired, it listens for the time lag in the coded radio transmissions. Recall that the radio transmissions of each GNSS satellite contain the output from a high-precision timekeeping apparatus. The disparity in the coded time as received by the GNSS receiver will allow it to shift the code of the second satellite until it aligns with the output of the first satellite. Once the time difference in the two codes is know, it is possible to conclude the size of the radius of the sphere defined by the propagation of the radio signals from the second GNSS satellite, R2. Since the satellites are in orbit at known locations, it is possible to imagine that the radius from each of the satellites defines a sphere. The spheres from each satellite intersect in two locations. The intersection of the two spheres describes an arc circumscribed about the faces of each sphere.

Once the signal from a third GNSS satellite is received, another similar calculation is performed to determine the distance from the GNSS receiver to the third satellite to obtain R3. Again, using information about the orbit of the satellites, the three spheres will define two points where all three spheres intersect. One of the intersection points will be nonsensical and it may be discarded. The other intersection point represents a two-dimensional position estimate of the location of the GNSS receiver with respect to the planet.

In a similar fashion, coded radio transmissions from a fourth GNSS satellite may be acquired. Once a distance from the GNSS receiver to the fourth satellite is calculated as R4, the intersection points of the spheres defined by R1, R2, R3 and R4 will yield a three-dimensional position report for the GNSS receiver's location. As coded radio transmissions from additional GNSS satellites are received, it is possible to solve the system of simultaneous equations and arrive at a GNSS position calculation that contains a higher degree of accuracy.

A Differential Global Positioning Receiver (DGPS) is an apparatus that provides enhanced GPS position reports. DGPS is capable of significantly reducing the error term in a GPS position measurement. Differential GPS relies on a DGPS base station located at a well known reference location and DGPS-capable receivers located on the autonomous objects.

The DGPS base station is configured to contain a very accurate value for its exact location. The value may be obtained by geometric and trigonometric calculations or it may be composed by a long-duration GPS position survey. The long-duration GPS position survey consists of a collection of GPS position measurements at the base station location. When graphed, the individual GPS position measurements will create a neighborhood of points. Specific points in the neighborhood will be measured with an increased frequency and, after a sufficient period of time, a mathematical expression of a position can be constructed there from. This position is the most-likely position for the DGPS base station location and, from a probabilistic point of view, represents a more accurate approximation of the DGPS base station's location.

While the described system is in operation, the differential GPS base station monitors GPS radio signals and continuously calculates its measured position from them. The calculated position is compared with the configured, well-known position and the difference between the two positions is used to formulate a correction message.

An artifact of the GPS GNSS is that since it is possible to determine the error term for a specific location, all points within a neighborhood of that position also contain approximately the same error term. Since it is possible to measure the error term at a specific location, (the differential GPS base station) the error term for all nearby positions is therefore known.

The Radio Technical Commission for Maritime Services (RTCM) has developed a specification for navigational messages generated by Global Navigation Satellite Systems. That specification is known as RTCM-104. The differential GPS base station constructs RTCM-104 format differential GPS error correction messages. Differential capable GPS receivers can process position error correction messages as specified in RTCM-104 standard. The differential-capable GPS receiver co-located with the autonomous objects instantaneously calculates the object's position and applies the correction data from the RTCM-104 packet to yield a highly accurate position calculation. This measurement is transmitted over the aforementioned communications device for processing at a base station. The RTCM-104 correction messages are also transmitted via the communications device to the differential-capable GPS receivers co-located with the autonomous objects.

When a two-dimensional position calculation is performed by a GNSS system, the error term is known as Circular Error Probable (CEP); when the position calculation is made in three dimensions, it is known as Spherical Error Probable (SEP). CEP and SEP express the size of the radius of a circle or sphere, respectively, and represents the possible deviation from the calculated position of the object's true location. The CEP and SEP measurements represent a maximum likelihood confidence interval for the position estimate.

The error term that is part of a GPS position calculation is caused by a host of factors. Range calculation errors are induced by atmospheric distortion. As radio signals propagate through the earth's atmosphere, they are distorted by moisture and electrically charged particles. Radio signals from satellites at a lower elevation relative to the horizon must traverse more of the planet's atmosphere than radio signals from satellites positioned directly over the receiver.

Another source of GPS calculation errors are the minute orbital perturbations of each global positioning satellite at any given moment. GPS receivers are aware of the theoretical position of each GPS satellite, but they cannot tell the true position of each satellite. The true position of a GNSS satellite may be better approximated by computationally correcting for the satellite's orbital location. Keplarian orbital elements for each GNSS satellite may be obtained from authoritative sources. The Keplarian orbital elements describe an individual satellite's kinematical state at a precise time. Prior art describes techniques that allow for an accurate estimate for the satellite's true position to be derived computationally. Factors such as gravity and atmospheric drag may be modeled to produce an accurate orbital position estimate. Better estimates for a GNSS satellite's instantaneous position will yield better values for Rₙ and will consequently yield better GNSS receiver position estimates.

There are many schemes that have been mentioned in the prior art that enhance a GPS receiver's ability to minimize the error term in a position calculation. While global positioning receivers are able to make a two-dimensional position calculation with a fair degree of accuracy, the atmospheric distortion and orbital perturbations cause severe problems when a GPS receiver attempts to make a three-dimensional position report that includes an elevation above Mean Sea Level (MSL).

The need to deal with the error term in the three-dimensional case has motivated the need for satellite-based correction systems (SBCS). In a SBCS, a network of ground stations continuously monitors transmissions from the GPS constellation. Each SBCS ground station is at a well-measured location on the planet. At any moment, the ground station can produce a correction message that represents the error in the GPS signal for the neighborhood around the ground station. The correction message reflects the effects of the GPS atmospheric and orbital ranging errors. The ground station's correction message is then sent up to a communications satellite, which, in turn, sends the correction message to all GPS users. The correction message is pure data and it is not subject to distortion concerns. GPS receivers capable of monitoring the correction messages from the communications satellites use the messages to fix up their own GPS position calculations. The result is a very accurate, three-dimensional position calculation.

The United States Federal Aviation Administration (FAA) is deploying such an error-correcting GPS system. The system is known as Wide Area Augmentation System (WAAS), and two WAAS satellites provide GPS users with correction messages from a network of 25 ground stations in the continental United States.

Even with the advances provided by SBCS, GPS receivers still have a minimum number of satellites requirement and are sensitive to radio multi-path issues and interference concerns. For this reason, it is desirable to combine a GPS position reporting mechanism with another position measurement system. Each system can perform a position calculation and the results may be compared. When the quality of one system's calculation degrades, it may be ignored and position reports may be derived from the other system.

GNSS satellite visibility is dependent on a host of factors. The Navstar GPS system consists of a constellation of 24 satellites in 6 orbital planes. This orbital array generally results in acceptable coverage for most points on the planet. The GPS Space Vehicles (SV) are not in geostationary orbits, rather they are in orbits that have a period of nearly 12 hours. This means that if an observer stood still at a specific location, the location and number of GPS SV's in view would constantly change.

GPS receivers generally are configured to reject signals for GPS satellites that appear to be very low on the horizon as their signal is most likely distorted by its long path through the atmosphere and by objects that obstruct the lower portion of the sky (nearby trees, buildings, etc.). Since the accuracy of GNSS systems is sensitive to how many satellites are in view, it is conceivable that the tracked object may be in a position where it is not possible to view a sufficient number of satellites to adequately and precisely calculate its position. Various combined approaches have been used in state of the art systems to address these deficiencies.

One such approach is to use an Inertial Measurement Unit (IMU) in addition to a global positioning receiver. The IMU is a device that measures magnitude and change in motion along three orthogonal axes that are used to define a coordinate system. The IMU produces data for roll, pitch, and yaw, roll velocity, pitch velocity and yaw velocity. Additionally, the inertial measurement unit can produce reports for X velocity, Y velocity and Z velocity. The inertial measurement unit is aligned at a known location a priori, and incremental updates from the IMU yield a piecewise continuous picture of an object's motion. Integrated over time, it is possible for the IMU to produce a position report.

An IMU is also capable of measuring translations in the axes themselves. For this discussion of coordinate systems, we will define the following terms:

X-axis—is the axis that is parallel to lines of earth latitude.

Y-axis—is the axis that is parallel to lines of earth longitude.

Z-axis—is the axis that is parallel to a radius of the earth.

Roll—is defined to be a rotational translation of the Y-axis of a coordinate system.

Pitch—is defined to be a rotational translation of the X-axis of a coordinate system.

Yaw—is defined to be a rotational translation of the Z-axis of a coordinate system.

Each one of the above terms defines a Degree Of Freedom (DOF) for the coordinate system. A Degree Of Freedom means that an object can be moved in that respect and a corresponding change in the object's location and orientation can be measured. The usage of X-, Y- and Z-axes as well as the concepts of roll, pitch and yaw is known to those skilled in the art.

An IMU is calibrated with an initial position at a known time. As the IMU operates, periodic data from the unit is used to drive a system of equations that estimate an object's position and state of motion. The model driven by data from the IMU can then be used to drive a model of motion that is independent from the model driven by the GNSS receiver. If the quality of data produced by the GNSS receiver degrades due to any number of factors, the kinematical state of the tracked object driven by data from the IMU can then be used to supplement the tracked object's position estimate. Data generated by both measurement devices that are co-located with the tracked object are transmitted to a terrestrial computer system that maintains the kinematical models for all tracked objects.

In a similar fashion, either one of the position measurement devices may be replaced with any number of technologies that perform a position measurement function. In particular, the GNSS receiver may be replaced with an Ultra Wide Band (UWB) radio system. UWB radio systems can produce position measurement reports that correspond to where a UWB transceiver is located with respect to other UWB transceivers. Since UWB is a terrestrial radio system, the effects of atmospheric distortion of the radio signals are orders of magnitude less than GNSS systems.

There have been various attempts related to tracking and identification of objects. It also is readily apparent that the ability to track an object results in certain additional information that may be beneficial data for a sporting event. For example, U.S. Pat. No. 6,304,665 ('655) describes a system that can determine information about the path of objects based upon the tracking data. Thus, when a player hits a home run and the ball collides with an obstruction such as the seating area of a stadium or a wall, the '655 invention can determine how far the ball would have traveled had the ball not hit the stadium seats or the wall. Related U.S. Pat. No. 6,292,130 ('130) describes a system that can determine the speed of an object, such as a baseball, and report that speed in a format suitable for use on a television broadcast, a radio broadcast, or the Internet. In one embodiment, the '130 system includes a set of radars positioned behind and pointed toward the batter with data from all of the radars collected and sent to a computer that can determine the start of a pitch, when a ball was hit, the speed of the ball and the speed of the bat.

Another related patent is U.S. Pat. No. 6,133,946 ('946) for a system that determines the vertical position of an object and report that vertical position. One example of a suitable use for the '946 system includes determining the height that a basketball player jumped and adding a graphic to a television broadcast that displays the determined height. The system includes two or more cameras that capture a video image of the object being measured. The object's position in the video images is determined and is used to find the three-dimensional location of the object.

While the use of moveable cameras has been widely employed for many years, there is a limit as to the speed at which an individual camera can move without distorting the picture. As an example, many users of video recorders move the camera too quickly and the result is a jerky presentation of the video events that is difficult to follow and has little value to the viewer.

A Camera for sporting events may also be equipped with a variety of pan, tilt and/or zoom features that generally rely upon some form of human involvement to employ a particular camera at a particular view of the event. It is common in large arenas to utilize multiple cameras and have skilled operators in a central location coordinate the various images and improve the viewed event by capturing the more important aspects of the game in the best form. This also allows some discretion and redaction of scenes that are unfit for transmission or otherwise of lesser importance. U.S. Pat. No. 6,466,275 describes such a centralized control of video effects to a television broadcast. Information about the event that is being televised is collected by sensors at the event and may be transmitted to the central location, along with the event's video to produce an enhanced image.

In addition, there have also been attempts to coordinate the relationship between an object that is being televised, such as a race car, golf ball or baseball, so that the cameras keep the object in the field of view. For example, U.S. Pat. No. 6,154,250 describes one system that enhances a television presentation of an object at a sporting event by employing one or more sensors to ascertain the object and correlate the object's position within a video frame. Once the object's position is known within the video frame, the television signal may be edited or augmented to enhance the presentation of the object. U.S. Pat. No. 5,917,553 uses sensors coupled to a human-operated television camera to measure values for the camera's pan, tilt and zoom. This information is used to determine if an object is within the camera's field of view and optionally enhance the captured image.

The use of global positioning systems to track objects has been implemented with varying degrees of success, especially with respect to three-dimensional location of objects. Typically, GPS receivers need valid data from a number of satellites to accurately determine a three dimensional location. If a GPS receiver is receiving valid data from too few satellites, then additional data is used to compensate for the shortage of satellites in view of the GPS receiver. Examples of additional data includes a representation of the surface that the object is traveling on, an accurate clock, an odometer, dead reckoning information, pseudolite information, and error correction information from a differential reference receiver. The published patent application U.S. Ser. No. 20020029109 describes a system that uses GPS and additional data to determine the location of an object. U.S. patent applications Ser. Nos. 20030048218, 20020057217 and 20020030625 describe systems for tracking objects via Global Positioning Receivers and using information about the objects' location to produce statistics about the object's movement.

U.S. Pat. No. 5,828,336 ('336) describes one differential GPS positioning system that includes a group of GPS receiving ground stations covering a wide area of the Earth's surface. Unlike other differential GPS systems wherein the known position of each ground station is used to geometrically compute an ephemeris for each GPS satellite, the '336 system utilizes real-time computation of satellite orbits based on GPS data received from fixed ground stations through a Kalman-type filter/smoother whose output adjusts a real-time orbital model. The orbital model produces and outputs orbital corrections allowing satellite ephemerides to be known with considerably greater accuracy than from the GPS system broadcasts.

The tracking of automobiles using global positioning systems is well known in the art and some vehicles are equipped with navigation systems that can display maps and overlay the vehicle position. The speed and direction are readily determined and allow for processing of estimated time of arrivals to waypoints and to end locations. For example, a system for monitoring location and speed of a vehicle is disclosed in U.S. Pat. No. 6,353,792, using a location determination system such as GPS, GLONASS or LORAN and an optional odometer or speedometer, for determining and recording the locations and times at which vehicle speed is less than a threshold speed for at least a threshold time (called a “vehicle arrest event”).

Despite the advantages achieved by the prior art, the industry has yet to accommodate certain deficiencies, and what is needed is a system that can track multiple targets in a dynamic fashion and provide a cueing path solution for robotically controlled, direction-sensitive sensors. The system should be able to isolate a single target moving at high rate of speed and among other targets. The system should be easily to implement for commercial use and have an intuitive interface.

### BRIEF SUMMARY OF THE INVENTION

The present invention has been made in consideration of the aforementioned background. One object of the present invention is to provide a system for dynamic tracking wherein positioning sensors are located in each desired target, along with a communications mechanism that sends the position reports to a central processing station. The central system processes the position reports from each target and uses this information to drive a system of linear kinematical equations that model each target's dynamic behavior. The system facilitates estimates of projected location of the moving target. Directional controllers are coupled to the central station and are provided the projected location information to track the target.

One embodiment of the invention is a system for dynamically tracking and targeting at least one moving target, comprising a position location receiver located proximate the target, wherein the position location receiver receives present location information of said target. There is a communicating apparatus coupled to the position location receiver and at least one base station communicating with the target. The communicating apparatus transmits the present location information to said base station, and the base station calculates a projection location information. In most instances the projection location information comprises historical location information as well as the projected location based upon calculations. There is at least one autonomous client station coupled to the base station, wherein the client station acts upon the projection location information.

In addition to the position report, the target may also communicate additional information to provide a measure of an observed or calculated state in the autonomous object's frame of reference. The communications device proximate the target may be of such nature that it only transmits information from the autonomous object or it may transmit and receive information. The data from the target is processed by the central processing location, where the measurement data is integrated into the model for the target.

Any environment that allows a position measurement is acceptable for the present system to function. The present invention can be used to track autonomous objects inside buildings, over vast outdoor areas or various combinations. As the tracked objects are autonomous, the position measurement system of the present invention does not restrict or constrain the object's movement.

A measurement device that employs radio navigation signals is one means of establishing location, however, it is important to understand that the present system described herein provides the flexibility to employ wide range position measurement technologies and either use the technologies as stand-alone measurement sources or complementary measurement sources. Since certain tracking computations are performed remotely from the autonomous objects, the computing system that executes the actual tracking and kinematical modeling handles how to integrate the position measurement reports. The devices on the autonomous objects can be simply measurement and data transmission devices, but may also integrate some computing power to process certain data.

One of the unique characteristics of the described invention is that any form of measurement unit may be used for obtaining the position reports. The present system is capable of selecting any position on or near the planet as a false origin and making all calculations relative to the false origin. Thus, there is no requirement that the false origin even be a nearby location. Combining results from multiple position measurement systems yields increased accuracy in the described system's behavior. However, it is not a strict requirement that multiple measurement systems be employed.

Still other objects and advantages of the present invention will become readily apparent to those skilled in this art from the following detailed description, wherein we have shown and described only a preferred embodiment of the invention, simply by way of illustration of the best mode contemplated by us on carrying out the invention. As will be realized, the invention is capable of other and different embodiments, and its several details are capable of modifications in various obvious respects, all without departing from the invention.

### BRIEF DESCRIPTION OF THE DRAWINGS

The present invention will be readily understood by the following detailed description in conjunction with the accompanying drawings, wherein like reference numerals designate like structural elements:

FIG. 1 is a top view perspective of the elements of one embodiment of the invention and the elemental relationship;

FIG. 2 is a diagrammatic perspective of one embodiment for a racecar showing the interrelated aspects of the elements;

FIG. 3 is a flow chart of the steps employed of the target tracking processing;

FIG. 4 is a diagrammatic perspective of the camera controller operations;

FIG. 5 illustrates the separation of the predicted data from selected data for the incoming data packets;

FIG. 6 shows the local and remote process creation of the Commander

FIG. 7 shows the use of an arbitrary origin position;

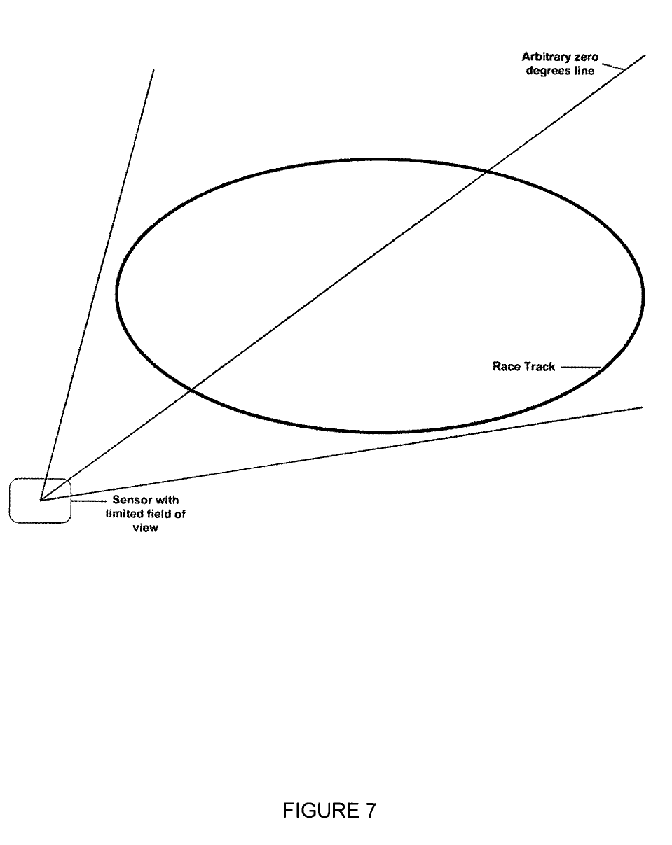

FIG. 8 shows the ability to adjust for arbitrary sensor zeroing;

FIG. 9 shows the increasing uncertainty of Kalman based positions over time.

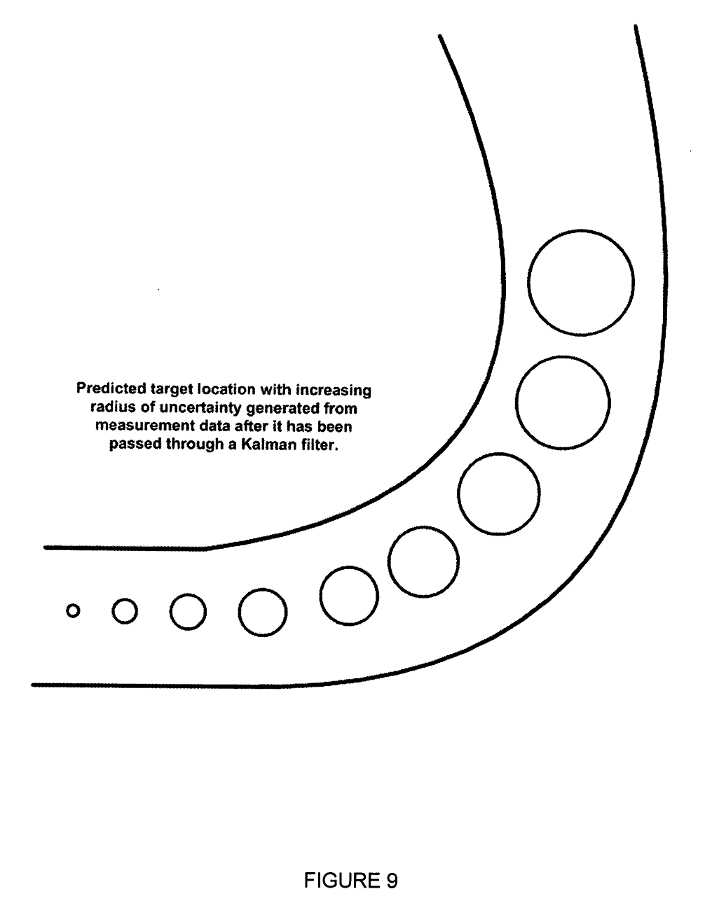

### DETAILED DESCRIPTION OF THE INVENTION

The apparatuses, methods and embodiments of the system disclosed herein relate to accurately tracking moving targets. The preferred embodiments are merely illustrations of some of the techniques and devices that may be implemented, and there are other variations and applications all within the scope of the invention.

In a general embodiment, one or more autonomous objects or targets carry one or more position measurement devices. The position devices periodically measure an object's position, wherein the measurements reflect the autonomous object's location at the instant the measurement was calculated. A communications device co-located with the measurement devices transmits each position measurement from the target to a central processing location that operates on the data and calculates various information including projected positions of the moving target. The projected position information may be used in conjunction with various autonomous directional sensors to maintain tracking of the target.

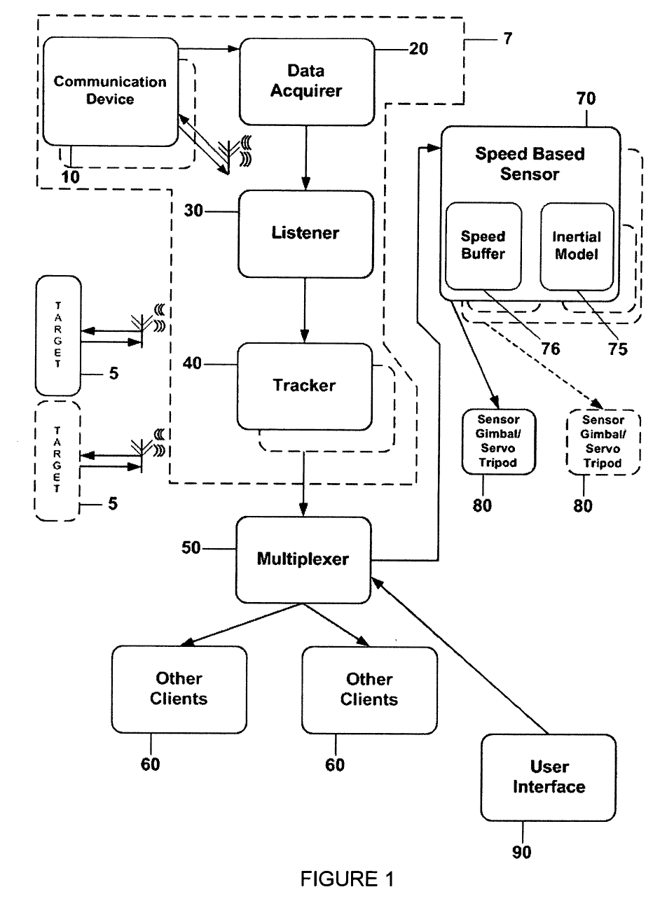

Referring to FIG. 1, a diagrammatic perspective for an embodiment of the processing is depicted. The target 5 is any mobile object that encompasses some position detectors capable of receiving position data and some means for communications to a central location. The position sensor requires accurate location information in a ‘real’ time environment. There are various position systems such as GPS, DGPS, WAAS, and UWB as well as various combinations thereof as described in more detail herein. The target receives the position information and there is a communications mechanism for transmitting the information as received or with subsequent processing prior to transmission. In addition to the location information coordinates, other information can be received or derived and transmitted. The communications mechanism can be any of the forms such as TDMA, CDMA, Ultra Wideband and essentially any of the wireless implementations and other protocols as described herein.

There is a central processing center 7 that receives and processes the information from the various targets. A communication component 10 receives the location information from the target and transfers the information for subsequent processing to the processing sections within the center 7.

The Data Acquirer section 20 receives data in a packet form from the system communications receiver 10. The communications channel allows a number of targets to access a single channel without interference and the data from the receiver 10 is communicated to the data acquirer 20 by any of the various wired or wireless means known in the art.

The data acquirer 20 does a minimal amount of integrity checking on each packet, and valid packets are then sent on to the Listener 30 and Trackers 40. The Position Listener 30 retrieves packets from the Data Acquirer 20 but does not block or excessively filter the data as it may contain possible signals of interest. The Listener 30 forwards all packets for subsequent processing according to the system requirements.

The Tracker 40 breaks the packet apart in to its constituent data fields and creates a data structure that represents the contents of the packet. This affords easy program access to the data contained in the packet. Each packet typically contains the following information, Timestamp, Latitude, Longitude, Elevation, Flags, End of data marker, and Checksum. Once decoded, the data structure that represents the packet contains Timestamp, Latitude, Longitude, Elevation, and Flags.

The timestamp associated with the packet represents the time that the position measurement was taken. The time is always some time in the past since the information was observed and then transmitted over a communications device before being decoded. The Tracker 40 integrates that position report in to its kinematical state model for that specific target and then processes the data to calculate an optimal estimate for the target's kinematical state. In a preferred embodiment the processing uses a Kalman filter. The optimal estimate for the target dynamics allows the Tracker 40 to project the target's location for a finite time delta into the future.

Once the Tracker 40 and the Kalman filter section have processed the data, a data packet is forwarded to the Multiplexer 50. The packet contains the most recently reported position and the first ‘n’ projected positions, wherein the system can be configured to support different values of ‘n’. In one embodiment, the Tracker 40 uses the optimal kinematical state estimate along with the equations of motion presented in the background for this invention to generate a current position and a series of expected future positions. These future positions can be calculated for arbitrary points in time. Depending on the needs of clients, time/position tupples for a small number of points far in the future, a large number of points in the near future, or any combination thereof may be obtained.

The Multiplexer 50 receives tracking data for all targets from the Tracker 40. The Multiplexer 50 performs the processing necessary to manage the set of client subscription lists for the various Clients 60. The Multiplexer 50 but it does not necessarily process every data packet. Until a client/subscriber connects to the Multiplexer and subscribes to a particular data feed, the Multiplexer 50 does not process the packets it receives. The Multiplexer 50 acts in a similar fashion as the server in a public/subscribe model with the clients.

A client need only register itself with the Multiplexer 50 in order to be assured of receiving all of the data for its selected targets. For example, a subscriber can access the User Interface 90 and request information such as visual tracking of a racecar. This would invoke a process that would identify the target and activate the appropriate client, such as the Speed Based Sensor 70 to track that particular racecar. There is a special target identifier that instructs the Multiplexer 50 to send the data for all targets to any client that chooses to ask for all data on all targets. Each data feed contains a unique identifier that positively identifies a specific target, which has a number of performance advantages.

For the Speed Based Sensor client controller 70, the Multiplexer 50 transmits the appropriate data to the processing section or sensor controller 70 that, in turn, communicates with the Sensor Gimbal/Servo Tripod 80 to track the target. The Speed Based Sensor controller 70 can be co-located with the central processing system 7 or it may be co-located with the Sensor Gimbal/Servo Tripod 80 and receive commands from the Multiplexer 70 via a communications medium (wired, wireless, optical, etc).

The User Interface 90 allows for certain variable initialization/settings, system configuration, startup, shutdown and tuning. The User Interface 90 has three main capabilities: starting processes, sending messages to processes and editing the system configuration data. While a graphical user interface (GUI) is the most common form of human to computer interface, there are various other forms of interface to provide the necessary information required by the system. For example, speech recognition directly or via a telephone is possible as well as a more mechanical button/slider/joystick interface. The User Interface 90 allows real-time interaction with the system.

The Multiplexer 50 communicates with the other various elements and acts as the gateway between the Client/Subscribers 60 and the data flow. The Target 5 communicates with the Multiplexer 50 via the processing stages, and the Multiplexer 50 communicates with the various components of the system 60 and 70. The Multiplexer 50 will typically be a subscription-based component that allows data to be sent to multiple client applications. While the subscription can be a pay or free subscription, it provides a mechanism to control the content feed to the subscriber and establish the desired preferences for the individual subscriber.

As the gatekeeper, the Multiplexer 50 communicates with one or more Client Controllers 60 and 70 such as Speed Based Sensor controller. It should be readily understood that there any number of clients/subscribers 60 and 70 that can be incorporated and serviced. Each Client may use position information in a context specific manner. For example, some clients such as a camera or directional microphone must orient a sensor toward the target. Other clients such as a lap counter or scoring system must maintain a model of position of a target relative to a fixed point such as a start/finish line. Still other clients such as a statistics generation client must analyze the motion of the targets without special regard to any fixed location.

The directional sensor class of clients is the most sophisticated from a positioning point of view as they must dynamically move a sensor so that the area illuminated by the sensor overlaps the dynamic position of the target. It must also calculate the time required to point a particular sensor. Some sensors such as gimbal mounted lightweight directional microphones can achieve and sustain high rates of both rotation and directional acceleration. Other sensors such as massive television cameras are too heavy for high degrees of acceleration and television audiences dislike extremely high rates of camera rotation.

Referring again to FIG. 1, this embodiment describes the implementation of a directional sensor such as a Sensor Controller. It should be noted and understood that the system supports the simultaneous use of multiple and disparate types of clients. The directional sensor is responsible for keeping the sensor device such as a camera or directional microphone on the target(s) 5 as the target moves. The directional sensor typically employs a servo/gimbal system to quickly move and point the individual device at the moving target according to the position information about the future location of the target 5. The Tracker 40 is responsible for the dynamic processing of the object(s) or target(s) 5 position information. The Sensor Controller 70 performs the processing necessary to generate the control instructions to be sent to the servo/gimbal of the directional sensor to align it with the precision required to maintain the directional sensor, such as the Camera Controller, on the moving target. This is done with Inertial Model 75 parameters compatible with the particular type of sensor.

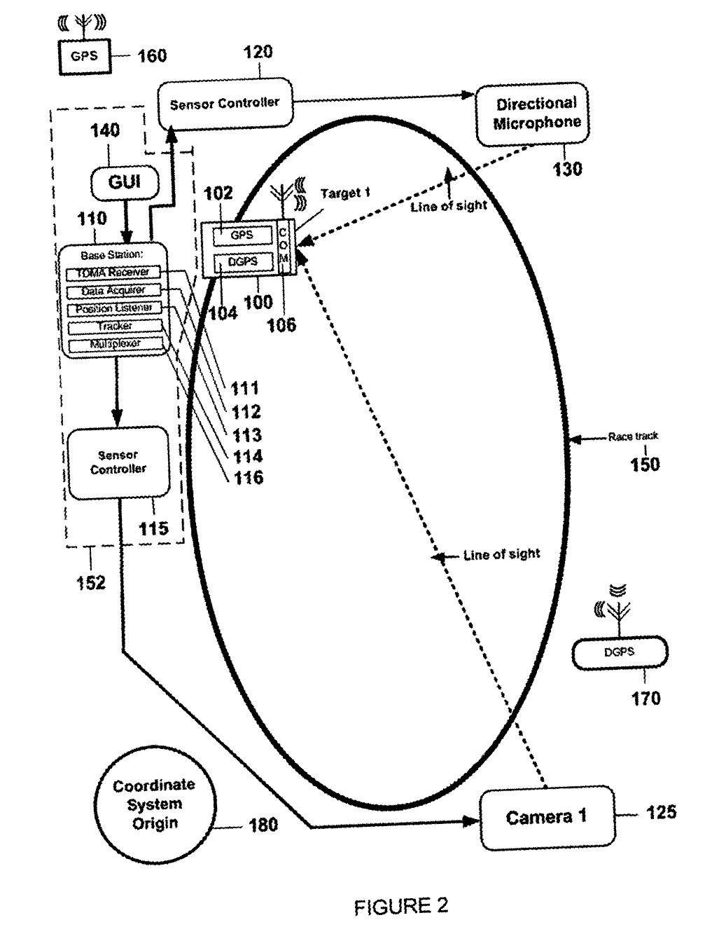

FIG. 2 contains a diagrammatic layout of the major components in one embodiment of the invention for a racecar competing on a racecourse 150. Each vehicle 100, such as Target 1, typically includes a GPS receiver 102 and differential-capable GPS receiver 104. It should be understood that the GPS and DGPS may be a single unit, and further that any accurate time based positioning system would be a substitute. Target 1 100 transmits this position over a Communications apparatus 106 in structured packets. These packets are sent at a configurable rate but generally 5-10 packets per second for each vehicle. Communications apparatus 106 receives information such as RTCM-104 Differential GPS corrections messages; other information may be received as well. The Communications apparatus 106 may be a TDMA radio system, CDMA radio system or an Ultra Wideband radio system. It is crucial to note that as detailed herein, TDMA, CDMA, GPS, DGPS, and UWB are for illustrative purposes and other implementations are within the scope of the invention.

There is a base station 110 that is a central processing center for gathering and processing the target information. The base station 110 is comprised of a communication receiver and a computer system. In particular, in this embodiment, a TDMA Receiver and a computing apparatus are co-located. On the computing apparatus, processes that implement a Data Acquirer, a Position Listener, a Tracker and a Multiplexer are executed. The TDMA Receiver consists of a small hardware device with a single input and a single output suitable for communication with a computing device and an antenna to send and receive data to and from Targets 100. The communications TDMA receiver is connected to the computer via an input/output medium such as a serial communications link, Universal Serial Bus or a computer network. Essentially any communications technique is within the scope of the invention.

The sensor controllers 115, 120 can be co-located with the central station 152, or remotely located, with the sensors 125, 130 mounted on the appropriate servo systems to support the tracking functions. In this embodiment, two sensors 125, 130 are deployed about the racetrack 150 and each has a line of sight of the target 100.

One of the software components or modules of the station 110 is the Data Acquirer 112 that listens on the serial port for all of the packets received by the communications apparatus 111. It is highly optimized to receive packets quickly. These packets are passed through a validation filter and invalid packets are dropped. Several levels of validation are performed on the packet so as to ensure that other modules downstream of the Data Acquirer 112 can assume valid packets. Packets are validated for correct length and internal format and also for a strictly increasing sequence number. Although the checks are extensive they are designed to be computationally trivial so as not to slow down the reception of succeeding packets. Packets passing the validation filter are then sent through another computer communication mechanism, possibly a computer network, to the next processing component. This next component may be co-located with the Data Acquirer 112 or it may be on another computer.

In addition to efficiently processing incoming packets, the Data Acquirer 112 also supports extensive recording (logging) and playback capabilities. It can log incoming packets in several ways. It can log the raw bytes it receives from the communications apparatus 111 and/or it can log only those packets passing the validation filters. The raw data log can be useful to check the health of the communications apparatus 111 and GPS systems 102, 104 on Target 1 100, both in the lab and in the field. Since in the field some packets do in fact arrive corrupted it is important to be able to test and verify that the overall system can process such packets. The log of packets that passed the validation filter can be useful to determine exactly what data stream is being sent to the downstream components. The Data Acquirer 112 can also create a data file of packets that it can later read instead of reading ‘live’ packets from the communications apparatus 111. This feature gives the system the ability to replay an arbitrarily long sequence of tracked object position reports.

The next component consists of two sub-components called the Position Listener 113 and the Tracker 114 of the station 152. The Position Listener 113 uses high-performance, threaded input/output technologies to read the packet stream from the Data Acquirer 112. It then feeds each received packet to one of several worker threads running the Tracker code 114. The reason for this split is to support a high level of performance. Depending on the number of targets, the Data Acquirer 112 may send the Position Listener 113 a large burst of packets at a time. The Position Listener 113 is designed to be able to service the incoming data packets fast enough so that they are not lost and do not block reception of additional packets. At the same time, the Tracker 114 has the flexibility to perform significant amounts of processing on some or all of the packets. These opposing requirements are resolved via the use of high-performance, threaded input/output technologies.

Various computer operating systems provide different mechanisms for achieving the highest level of Input/Output (I/O) performance. On Microsoft Corporation platforms that support the full Win32® set of features, Completion Ports are the recommended pattern for achieving the highest level of I/O performance. On various Unix®-type platforms, asynchronous I/O signals are the recommended pattern for achieving high-performance I/O. It is important to note that Completion Ports are discussed here for illustrative purposes. Other I/O techniques that provide peak performance on a particular computing platform are within the scope of the invention.

A completion port is a software concept that combines both data and computational processing control. The completion port maintains a queue of completed I/O requests. Processing threads of control (“threads”) query the completion port for the result of an I/O operation. If none exist, the threads block, waiting for the results of an I/O operation to become available. The processing component of the Position Listener 113 is implemented as multiple, independent threads of control. Each thread retrieves data from the completion port and begins to process it. After processing, the thread issues another asynchronous I/O request to read another packet from the Data Acquirer 112 and then it goes back to retrieve the next queued I/O request from the completion port.

The ‘n’ worker threads in the listener 113 invoke the Tracker 114. A programmatic object represents each vehicle 100 within the Tracker 114. As a point for a specific vehicle is received, it is integrated in to the programmatic model for that vehicle. Because the position measurement device that measures the vehicle's location inherently contains a measurement error, a Kalman filter is used in the Tracker 114 to make an optimal estimate about the vehicle's true position. By employing the Kalman filter to provide optimal estimates for position reports, the kinematical state model for each Target 100 produces optimal estimates for the vehicle's velocity and acceleration and jerk.

After the Tracker 114 worker thread has integrated the position report in to the vehicle's model, it uses the resulting state vector to project where the vehicle will be at discrete times in the future. The predictions are accurate for a neighborhood of time beyond the time that the position report was received by the Tracker 114.

For each packet that the Position Listener 113 and Tracker 114 receives, it generates a data packet that consists of the actual position along with ‘n’ predictions. These data packets are sent to the next downstream component, the Multiplexer 116. The Multiplexer 116 is a subscription-based component that allows data from the Tracker 114 to be sent to as many client applications as are interested in it.

The Multiplexer 116 employs multiple threads of control along with completion ports to maximize the throughput of data. In this way, the Multiplexer 116 processes the reception of data from multiple targets, quickly ignoring target data for which there is no current registered client and forwarding each data packet that does have one or more interested clients.

A client makes initial contact with the Multiplexer 116 on the Multiplexer Control Channel. The Multiplexer then creates a unique communications channel to exchange data messages with that application. The initial request specifies whether the client application will be a provider or consumer of data. If the application is a provider of data, the Multiplexer 116 retransmits data received from that client to all other clients that are interested in it. If the application is a consumer of data, then the Multiplexer 116 sends that application only data pertaining to targets that the client has named in its connection request. A client may also request information about all the target vehicles. An example of client that would request messages about all targets would be a statistics or scoring client. Such a client needs access to the position of each target at all times. A sensor client such as a camera controller, on the other hand, is associated with one target at a time.

The architecture provided herein affords that various types of client components may be produced. The basic component is the Client Controller class from which all client classes are derived. The Client Controller class provides the canonical communications functionality that all clients require. In addition to reducing the engineering requirements on a client, it also enhances the overall stability of the system by ensuring that all clients do the basic communications tasks in an identical manner.

Each client application performs a number of steps to initialize itself and establish its communication channels. It creates two specially communications channels. One channel is used to receive data from the Multiplexer 116, the other is used to receive commands. All clients support the ability to receive commands from other clients and/or other components of the system. In this way the overall system can tune itself by informing all components of changes in configuration or target behavior. Such messages are sent to the Multiplexer 116 with a destination name that corresponds to the desired component's control channel.

The client then registers with the Multiplexer 116 and informs it of the set of targets the client is currently interested in. The client then creates a thread object so that it has two active threads running. The main thread waits to receive target data from the Multiplexer 116 while the second thread waits to receive control messages.

In operation, the origin of the system may be any point above, below or on the surface of the WGS84 ellipsoid. The WGS84 ellipsoid defines a well known, shaped volume and coordinate system for the planet earth. The target positions and camera positions are given relative to a high precision origin location. Each camera controller calculates pan, tilt, zoom and focus for the line of sight to a particular Target 100.

The Sensor Controller 115 is an instance of the Client Controller and so it only receives packets for the target it has selected. It is implemented as three threads of control: a packet receiving thread, a sensor servicing thread and a command servicing thread. The receiving thread is a loop sitting on an efficient read of the communications channel connected to the Multiplexer 116. Using the same high performance I/O technology that was used upstream, the packet receiver pulls packets off the communications channel quickly so as to prevent backlog. Each packet contains an actual position and ‘n’ predicted positions. For each position, a calculation is performed to determine the parameters required to correctly point the physical sensor 125 associated with the Sensor Controller 115 at the requested target. These parameters include pan angle, elevation, zoom and focus.

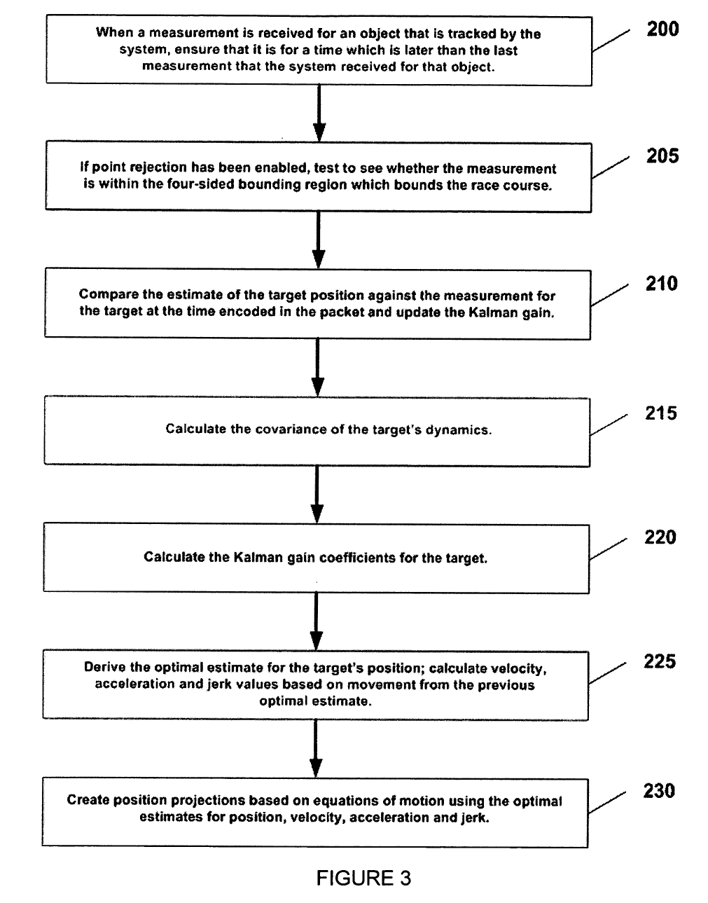

Referring to FIG. 3, a flow chart of processing commencing with a received measurement is described. According to the flow chart, the first step 200 commences once a measurement is received for an object being tracked. There is an initial check to ensure the data is the latest measured value. It is conceivable that the communications device could deliver the measurements out of order. To ensure that the system does not mistake an out-of-order packet for a true movement of the target, the processing algorithm checks to make sure that the measurement times for packets accepted by the system continuously increase.

If point rejection was enabled, there is a check to determine whether the measured data is within the four-sided polygon bounding the racecourse 205. This feature of the packet processing is vital to guard against well-formed packets that contain nonsensical measurements. The system allows four points relative to the false origin to be specified to describe a bounding polygon. The sides of the polygon need not be regular, but the points need to be specified in an order such that they trace a closed path around the edges of the polygon. No edge of the polygon may cross another edge of the polygon; the bounding polygon must be strictly concave or convex.

To test whether a point is contained within the bounded region, an imaginary line is created from the point to another point in the coordinate space that is infinitely far away. The line is tested to see if it intersects with an odd number of edges of the bounding polygon. If the number of crossings is odd, the point is determined to be within the region of interest; if the number of crossings is even, then the point is rejected as it is outside the edges of the bounding polygon.

At this point, the algorithm compares the measured target position against the estimated target position for the time indicated in the packet. This information is essential for the Kalman filter. It allows the filter to tune the gain coefficient based on the fidelity of the a priori estimate versus the actual measurement 210.

Calculating the covariance of the targets dynamics is the next step in the process 215. Updated Kalman coefficients are calculated in step 220.

Step 225 calculates an optimal estimate for the target's true, present location. Based on the previous optimal estimate, values for velocity, acceleration and jerk are also derived. These calculations are carried out for the three dimensions of the coordinate system. Finally, in the last step, 230, position projections are generated by inserting the optimal estimates for position, velocity, acceleration and jerk in to the equations of motion and stepping the value of time forward for discrete intervals. In this way, the algorithm creates a set of optimal estimates that reflect measurement data and the recent historical accuracy of the measurement device.

After the packet is processed by the tracker, the actual position report and the ‘n’ projected position reports are sent to the Multiplexer 50, FIG. 1 to be distributed to any interested clients. The position report packet contains a target identification number so that the Multiplexer 50 may determine which clients, if any, should receive a copy of the packet.

With the position report packet finally received by the Speed Based Sensor controller 70, the controller calculates the absolute values required if the system wanted to instantaneously point the sensor at the target. It does not, however, necessarily send these exact values. Based on the prior and current motion of the Sensor Gimbal 80, the system may decide to smooth the translations of the different axes of the Sensor Gimbal 80. This decision is made based on knowledge about the Sensor Gimbal's 80 inertia and translation capabilities (stored in the Inertial Model 75) as well as possible knowledge about quality of presentation factors which may be specific to the sensor. For some sensors such as cameras, is more important to present smooth motion than it is to present the most accurate motion. The actual calculation consists of several sub factors: avoid reversals of motion, avoid jitter when the requested translation is very small, avoid accelerations greater than ‘x’ radians per second per second (where ‘x’ is configurable).

The first step in the blending process is to find the appropriate location within the Speed Buffer 76 to place a new position report. This location is referred to as a ‘bucket’. There are three distinct cases to consider when locating the correct bucket. It is important to note that each bucket within the Speed Buffer 76 has a timestamp associated with it and that each position report also has a timestamp.

The circular Speed Buffer 76 consists of ‘m’ buckets. In the first case, a new position report's timestamp might correspond exactly to the timestamp of an existing bucket. The system accepts the bucket in the Speed Buffer 76 as the appropriate bucket.

In the second case, the new position report's timestamp is between the timestamps of two existing buckets within the Speed Buffer 76. The system picks the bucket with the lowest timestamp that is greater than the new position report's timestamp.

Finally, the case in which the timestamp for the position report is later than any time in the circular Speed Buffer 76 is considered. The system determines which bucket currently holds the oldest timestamp and uses that bucket for the current report. Given the overlapping nature of the position packet reports (with each packet containing ‘n’ time values), the middle case tends to be the most common.

Once the proper bucket has been selected, the system calculates the angle required to point a direction-sensitive sensor towards the target given the sensor's location. This is done on a per client basis. In other words, only clients of that type requiring directional pointing perform this step and they only perform it for the target they are tracking. One exception to this rule is for compound targets. The strategy employed when writing to the Speed Buffer 76 for compound targets will be discussed later.

It is important to note a deliberate design choice that has been made in the area of what value is written to the circular Speed Buffer 76. The system separates the calculation of the angles required to point at the target from the mechanical plan of how to move the sensor from its current angle to the desired angle. This separation allows the cueing path to be independently optimized and drastically improves correlation and smoothness of the cueing instructions sent to the Sensor Gimbal 80.

The calculation of how to point a directional sensor at a target proceeds using standard trigonometric functions.

AdjacentLength=X_{target}−Xₛₑₙₛₒᵣ

OppositeLength=Y_{target}−Yₛₑₙₛₒᵣ

PanAngle=arctan(OppositeLength/adjecentLength)

The angle calculated by the prior formula determines a result within the range of zero to Pi and must be adjusted for the quadrant of the coordinate space that the actual angle resides in. This is due to the ranges for which the arctan function is valid. The adjustment is performed using the following formula:

For angles in quadrant 1: Panangle=PI−Absolute Value(panAngle)

For angles in quadrant 2: panAngle=PI+Absolute Value(panAngle)

For angles in quadrant 3: Panangle=(PI*2)−Absolute Value(panAngle)

For angles in quadrant 4: there is no adjustment necessary

Several other calculations are performed at the same time that pan angle is calculated and the results are stored in the bucket with the pan angle. The system computes the distance from the sensor to the target. Some sensors (such as cameras) can make use of this information to perform functions such as zoom and focus. In addition, the system calculates the elevation angle needed to point at the target. While changes in elevation are often less than changes in planar position, they do occur and must be accounted for.

Once all of these calculations are performed, the resulting values are blended into the circular buffer. The term blend is used to describe the process by which new values are combined with old values for the same time period. Keep in mind that each packet contains ‘n’ time/position tupples corresponding to a series of optimized position estimates. The circular Speed Buffer 76 contains ‘m’ buckets, wherein ‘m’ is chosen to be an integer multiple of ‘n’ so that when subsequent packets arrive, the can be blended with data in the circular Speed Buffer 76 that has already been blended from prior position reports. The later position estimates in the packet have a greater degree of uncertainty. Therefore, earlier packets with overlapping timestamps are given more credence in the calculations. The actual formula is:

Factor=(1/POINTS_PER_PACKET)*Position Within Packet

Angle=Old Angle*Factor)+Calculated Angle*(1−Factor)

This is calculated once for each position within a packet. For early points in the new packet, ‘factor’ is close to unity, meaning that the new value is given a great deal of weight compared to the old value in that time bucket. For later points within the new packet, ‘factor’ becomes increasingly small. The result is less weight given to the later points in the new packet and more weight given to the first few points in the new packet as they are blended with the existing values.

An outcome of using this highly blended approach is that each bucket will receive information from ‘n’ separate position reports where ‘n’ is the number of points per packet. This provides an additional level of implicit buffering and provides an extra level of certainly about the eventual contents of each bucket.

All of the preceding steps are simply to get values into the circular buffer. Getting them out of the circular buffer, and performing still more levels of smoothing is discussed next.

Before discussing the use of the data in the circular buffer there is another type of target that receives special attention: the compound target. The proceeding discussion is based on the premise that a single target reporting a single (instantaneous) position is being tracked. Depending on the type of sensor being used by a particular client, there may be issues of field of view. Field of view refers to the cone of sensitivity within which a sensor may receive data. This, of course, depends on the distance from the sensor to the target. There are sensors that may be configured to have a narrow field of view at a given sensor-to-target distance. This allows a single target to be viewed by a given sensor. An example of such a configuration is a narrow field of view shot of an individual vehicle at an automobile race.

There may be times, however, when the field of view is expanded to track several targets simultaneously. One approach that could be taken is to treat the compound target case as a type of zoom. In this approach, the sensor employs a zoom function to expand a field of view centered on a single, real target. The approach does not incorporate tracking data for more than one vehicle. Therefore, a second or third vehicle might be in the field of view, but only by chance.

A better approach is one that incorporates the tracking data from multiple targets. In the Position Tracker 40, there is logic that combines the packets for two real targets into a single composite position. The point chosen to represent the two targets is the midpoint on the line that connects the targets. This position is then propagated with a synthesized target identification through the rest of the system without any awareness by the system is the uniqueness of the target.

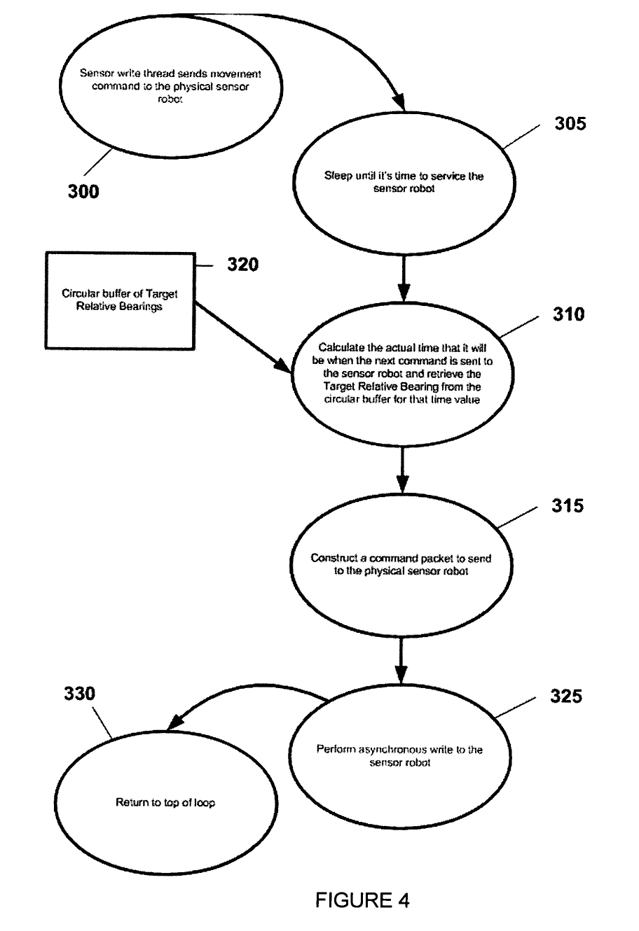

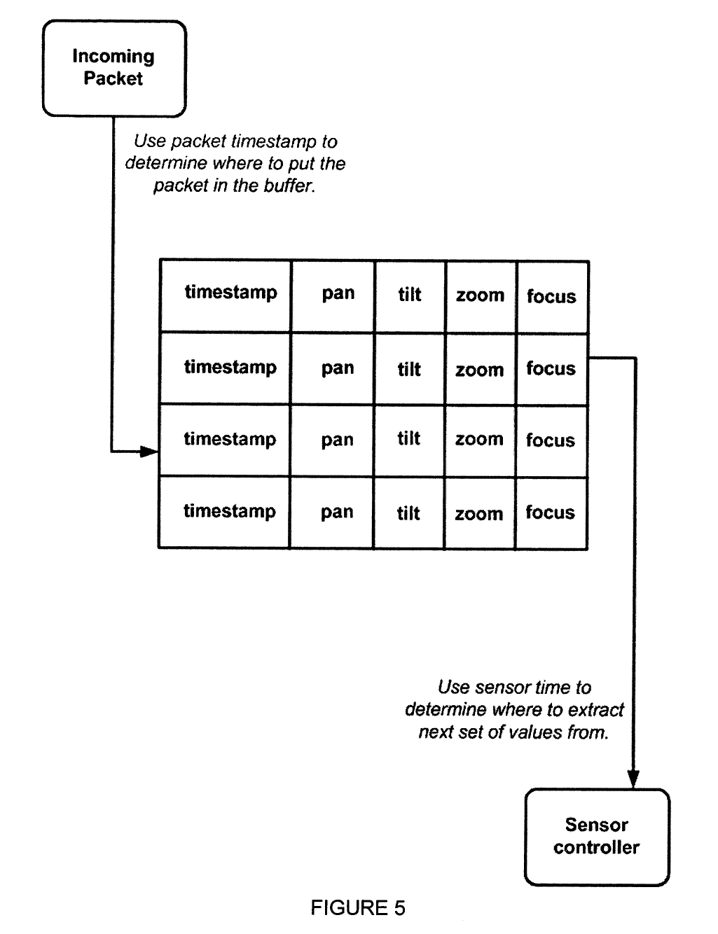

Referring to FIGS. 4, 5 and 6 the Client Controller's write-to-sensor thread is time based and designed to support a physical sensor robot that needs to receive commands every ‘x’ milliseconds in order to achieve smooth motion. This is only one single embodiment of a robot. Other robot embodiments accept commands, such as pan at 2 degrees per second, and continue to act upon them until commanded to do something else (such as pan at a different speed or stop panning). That sort of robot requires a different derivation of the final controller logic than the current Speed Based Sensor controller. The current architecture supports various robots and is not limited by the preferred embodiment description.

One Sensor Gimbal 80 which can be controlled by the system accepts absolute commands such as pan to 156.34 degrees as fast as possible and then stop. When it receives the next command from the sensor controller, it will pan again as fast as possible. It can be seen that a large pan command will result in a large positive acceleration up to the Sensor Gimbal's 80 maximum rotational velocity, a time spent panning at a constant velocity and finally a time of maximum pan rate deceleration. This is antithetical to the notion of smooth viewer experience and has to be overcome by the software system.

Due to this limitation, the writer thread of the Speed Based Sensor controller 70 has to account for acceleration issues when choosing values to send to the actual Sensor Gimbal 80. The performance characteristics of the Sensor Gimbal 80 are embodied in parameters stored in the Inertial Model 75. In addition to this, the writer thread has to account for the fact that the Sensor Gimbal 80 must be serviced on a schedule that is different that the schedule used to fill the time based circular Speed Buffer 76. Therefore, the writer thread sits in a loop and performs a timed wait whose duration is equal to a value slightly less than the Sensor Gimbal 80 intra-command interval. Each time the wait completes, the thread calculates the current time and then requests values for that time from the circular Speed Buffer 76. It then uses those values to build a packet of a format appropriate for the physical Sensor Gimbal 80 and performs an asynchronous write to it.

This calculation is performed as follows. First, the system calculates the appropriate bucket from the circular Speed Buffer 76 using the algorithms listed previously. Even the ‘best’ bucket will very likely have a timestamp that is slightly different from the time required (i.e. now). Therefore, the system picks two buckets that bracket the requested time and calculates where in that interval the request time falls. It then performs a scaling of the two bucket's angle values to achieve resulting value

time_diff=Time_{lower}−Timeᵤₚₚₑᵣ

percent_of_the_way_to_later_time=fabs((Time_{lower}−now)/time_diff)

Angle=(CircularBuffer[lower]*percent_of_the_way_to_later_time)+(CircularBuffer[upper]*(1−percent_of_the_way_to_later_time).

After calculating the requested angle, the system performs several additional levels of smoothing. First, the system checks for pan reversal. If the Sensor Gimbal 80 were currently panning in one direction and the requested pan angle would result in panning in the other direction. The transition has to be accomplished without inducing abrupt accelerations. A maximum allowable acceleration value is established as a configurable parameter to the Inertial Model 75, so as to account for different classes of sensors and servos. If the pan reversal acceleration exceeds the maximum allowable acceleration the acceleration is divided in half. More robust smoothing algorithms could be used but this simple test reduces the acceleration jerk by 50%.

Several types of bounds checking and scaling are still required for a robust system. The calculations above may in some cases return results greater than 360 degrees or less than zero degrees. While some sensor driving gimbals may be able to perform the necessary adjustments automatically, the system does not assume this. Therefore the system performs the following calculations to normalize the resulting angle.

If(panAngle>360 degrees)panAngle=panAngle−360 degrees

If(panAngle<0 degrees)Panangle=panAngle+360 degrees

Lastly, some Sensor Gimbal systems reverse the sense of the coordinate system. For example, in a unit circle zero is typically at the top with degrees increasing clockwise around the circle. Some sensors use that approach while other sensors increase the degrees as they move counterclockwise around the circle. In the case that sensing is reversed the system uses the following formula to adjust:

PanAngle=360 degrees−panAngle

Still another feature provided for by the system is the ability to set maximum rotational angles for a Sensor Gimbal 80. Some gimbals are designed so as to be able to rotate indefinitely in a particular direction. Other gimbals have limitation such that they might be able to perform two full rotations in a direction but no more. These restrictions can result from inherent limitation of a gimbal or simply from a cabling requirement, i.e. the power and/or data cables attached to the gimbal are attached such that indefinite rotation would result in tangle.

To protect against this the, system can be configured such that the pointing commands honor the gimbal's maximum rotational capabilities. Once that limited is reached the sensor is instructed to rotate in the other direction until it reaches a preset point from which it can again freely rotate.

In addition to calculating pan and elevation data, the system also needs the ability to calculate distance to target. Controllers that drive robots that have cameras mounted on them need the ability to send both zoom and focus information to their associated physical cameras. Although zoom and focus parameters are related to distance (for optical lenses), the specific values required vary for each size lens. The current system has a method for empirically calculating a set of formulae for each lens's zoom and focus curves. This is done using a sampling of points and a spline curve. Splines are mathematical formulas describing how to derive a continuous curve from a small sampling of points.

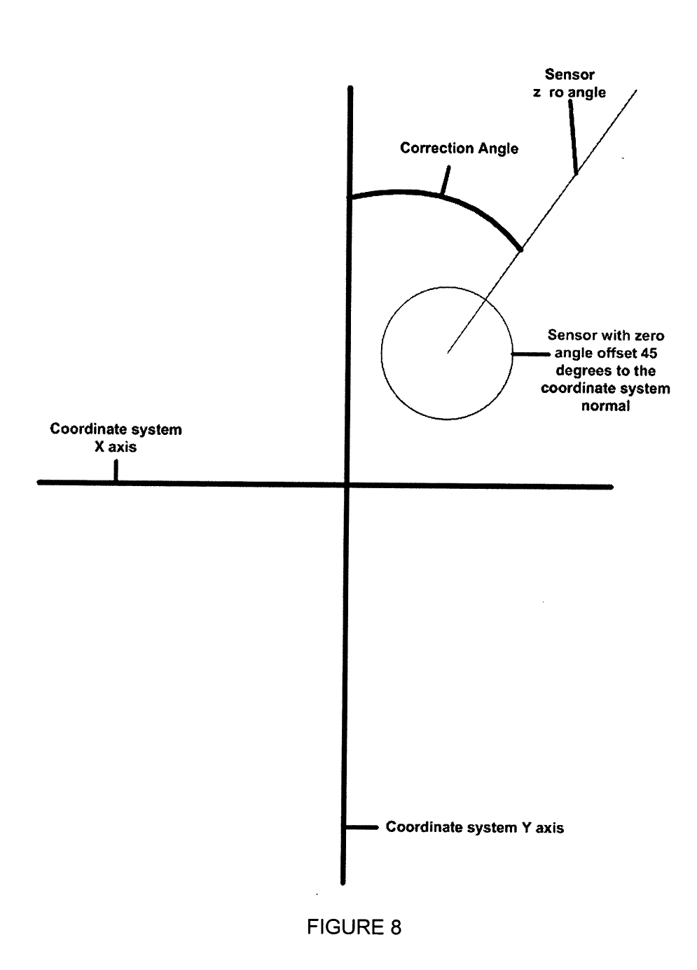

A further refinement of the system is the ease with which setup is performed in the field. Referring to FIG. 8, one feature of this easy setup is the ability to use an arbitrary value for zero degrees. This is important because some gimbal pointing systems cannot rotate a full 360 degrees. Some can only point 270 or even 180 degrees. For these systems it is important to be able to physically position the system so that the desire field of view from the sensor lies with the gimbal's rotational capabilities. The ability to establish an arbitrary zero degree position makes this easy.

Another type of client includes a client that is a scoring controller. It listens for packets from all targets and uses the information to determine when each target has crossed a defined Start/Finish Line. Each time a target crosses the Start/Finish line, it is considered to be on the next lap. Information about which lap each vehicle is on can be output. Although not a part of the current implementation, the scoring controller can also be made to output a set of statistics about the performance of each vehicle. Statistics includes such values as: current speed, time weighted speed, total distance traveled, maximum accelerations, etc. Such statistics would be considered valuable information by both racing fans and by racing teams. A large part of the strategy of racing is determining how often and when to stop to refuel and change tires. Knowing precisely how many meters a car had traveled would allow for greater accuracy in determining vehicle resource management strategies. Two possible clients are envisioned for this. One would be a race crew client that displayed technical details about the vehicle's motion. The second client would be designed specifically for racing fans. Many race fans possess Palm® or PocketPC® class devices with wireless networking capabilities. A client that received statistics about vehicles and then rebroadcast that data via a wireless data network to target applications on the handheld devices would be highly advantageous.

The scoring controller accepts as part of its configuration a pair of points that define the Start/Finish line on the course. Each time a point is received for a target, a line is constructed consisting of the new point and the target's previous point. A test is then performed to see if the target motion line crosses the Start/Finish line; if the lines cross the target is deemed to have crossed the Start/Finish line. Line crossing is determined using the standard algebraic line crossing formula. Each line is represented by the formula Y=MX+B where Y and X represent coordinates, M represents the slope of the line and B represents the Y-Intercept of the line. Given two lines, each represented by this formula, and given the fact that any two non-parallel lines contain an intersection point, a simultaneous solution can be found via the formula:

M1*X+B1=M2*X+B2

Or

X=(B2−B1)/(M1−M2)

A test is then performed to determine if the point where the two lines intersect lies on the Start/Finish line.

Still another type of client is a Course Enforcement client. Many sporting events have rules governing the locations where a player or vehicle can be located. Races cars are not allowed to go inside the inner edge of a track while in boat racing the vessels must not go outside the limits of the course. Any space that can be defined by a series of polygons can be represented as a space to be enforced. A client could be designed to listen to all packets and emit an alert if any target strayed outside of its allowed boundaries.

An important part of the configuration process is to establish the positions of all components of the system, including establishing the coordinate system origin. Most position reporting receivers can produce position reports in a variety of formats. One of the well-known formats is called Universal Transverse Mercator (UTM). UTM provides location reports that are based on meters of latitude and meters of longitude from certain fixed locations. While this is a useful system in general it tends to result in locations measured in very large numbers, such as 4,354,278 meters north by 179,821 meters east. Such large numbers are ungainly in the field. Therefore the system provides the capability to establish a false Coordinate System Origin 180, FIG. 2 that is overlaid on top of the native UTM coordinates. In FIG. 2, a high precision fix is taken somewhere on or near where the system is setup, often at the location of the DGPS 170 base station. This position is declared to be the origin and all subsequent positions are translated to be relative to this position. This results in coordinates that are far more human friendly. An operator can visually confirm that a camera is located 10 meters from the origin; they cannot visually confirm that the same camera is 4,100,000 meters from the equator.

Another advantage of the current approach is the ability to locate the origin at an arbitrary location. Depending on the particular venue it may be advantageous to locate the origin at a specific location. The current system supports this ability. One type of positioning of the origin that is often advantageous is to locate the origin such that the entire venue is at positive coordinate values. By contrast consider the case where the origin was positioned at the center of a venue such as a racetrack. In a standard Cartesian coordinate system there are four quadrants bisected by the X and Y axes. Only one quadrant has exclusively positive values for both X and Y. In this coordinate system a target will move between positive and negative values for X and Y as it moves. This can be a significant nuisance, especially for trigonometric functions that may not be defined for negative values. These calculations are simplified if an origin is specified which results in all positive values for all possible target locations.

As noted, the Commander GUI 140, FIG. 2 is responsible for system configuration, startup, shutdown and tuning. The Commander has three main capabilities: starting processes, sending messages to processes and editing the overall configuration file. Each function will be dealt with in turn.

The system configuration file is a human-readable text file that may be directly edited. Given the likelihood of introducing errors via manual editing, the Commander was developed to provide a Graphical User Interface that was both easy to use and which could perform error checking as illustrated in FIG. 11. Items in the configuration file tend to be either system setup related or tuning parameters. In order to use the system, all of the components need to know certain key pieces of data such as the location of the coordinate system origin, the locations of the various cameras, etc. There are also tuning parameters controlling details about target tracking. The following table is a sampling of the configuration data.

| | |
|---|---|
| Camera Names | used to refer to each camera in the various |
| | configuration dialogs |
| Active Cameras | each camera can be active or inactive |
| Camera Vehicle Targeting | which target is each camera tracking |
| Camera Position | GPS coordinates of each client |
| Camera Port | name of the serial port used to talk to a client |
| Client Machine | name of the computer on which a client is |
| | running |
| Use Recorded Data | the system can run from live or recorded data |
| Aiming Mode | the system can use GPS points to track |
| | targets or to align itself |

Further configuration data consists of the names of the various ports where components are attached to the various systems. All communication is accomplished via computer network communications protocols. Port names are an important piece of configuration information so that the system knows how to communicate with the various components (Data Acquirer 20, Position Listener 30, Tracker 40, FIG. 1 and so on.) In the same category is the list of which clients and which types of clients are to be started. This design allows new clients to be added or removed from the system simply by editing the configuration file.

Finally, there are a variety of tuning parameters governing the Kalman Filter parameters and how the clients deal with collected packets. An overall goal of the system is to be highly tunable and the configuration data satisfies this goal.

One method that makes the system more tunable is the way that a user can edit these configuration data. While some data is presented in simple data entry forms, other data is controlled via graphical user interface devices such as sliders. These sliders not only change the configured data but also send messages to the actual running program, providing immediate feedback.

An example a use of the zeroing parameter for the Sensor Gimbal 80 (FIG. 1) is when a camera is mounted to the Sensor Gimbal 80. This parameter controls the fact that the camera platform may not be aligned with the native coordinate system (as illustrated in FIG. 8). This means that when the camera points to a particular angle, that angle may not correspond to the same orientation in the underlying coordinate system. Therefore, the system provides a graphical slider whereby the operator can manually center the camera on the target. Once the target is centered, the offset is established so that values in the underlying coordinate system may be readily translated to the Sensor Gimbal's 80 coordinate system. The use of graphical editing systems allows an operator with a lower degree of training to be able to configure the system.

The methodology underlying the ability to dynamically tune the system is the command channel support provided by all components. This allows all components to accept incoming command messages. There is a semi-structured format to these messages that allows most messages to accept simple operation code oriented messages such as “shutdown”, as well as messages that encode entire data structures. Most messages in the current implantation take the form of “set the zero angle for sensor 3 to 247 degrees”.

A further aspect of the current invention employs a special mode whereby a target is positioned at set distances and the camera's zoom and focus values are manually adjusted for optimal viewing. At each discrete distance, the distance, zoom, focus tupple are recorded to a file. As many such reading as are desired can be captured. From this set of data separate splines may be calculated for zoom and focus. After this has been performed and an actual target is being tracked, the target's distance can be input to the spline formula that will output a zoom or focus value appropriate for that distance for the exact configuration of that sensor.

The splines are designed to result in a constant image size regardless of distance from the camera to the target. (This goal is limited in practice by the minimum and maximum focal lengths of the particular lens). The system also has the ability to allow an operator to specify a different image size. There may be times when the camera should be zoomed in tight to the target and other times when the preferred image is wider, showing the target and its background. The system provides a graphical interface to allow the operator to specify the type of shot desired. Internally the system responds to these requests by adjusting the distance that is input to the spline curve, effectively moving up or down the curve, resulting in a tighter or wider shot.

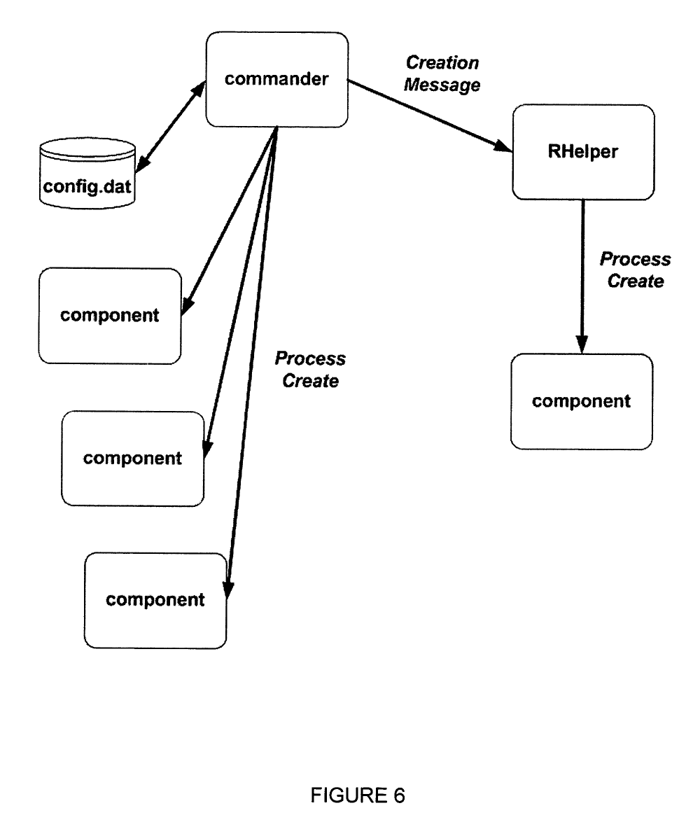

Another capability of the Commander is the creation of actual processes. An overview of the Commander showing the process creation local/remote is shown in FIG. 6. The Commander is the only component that needs to be manually created (except for distributed cases which will be discussed shortly). Once the Commander is running it can start all of the remaining components by simply using native process creation calls. After the components are started they are later shutdown by way of sending command messages.

One of the configurations that the current system supports is a distributed configuration. Since communication is done computer network protocols, the actual location and number of machines does not matter. In order to run the system in the distributed manner, a means is provided to bootstrap the system on remote machines. The present invention utilizes a software component called the RHelper to provide this capability. The RHelper routine is started on each machine participating in the overall system, and once running, the RHelper listens for process-start messages. The command start logic in the Commander looks at the name of the machine specified for each process, and if the machine is local, then Commander simply performs a process creation. If the machine is remote, the Commander sends a process creation message to the RHelper on the remote machine, and RHelper than performs the actual process create.

In racing applications, data for each vehicle or object is made available using a publish/subscribe system whereby a client component running either on the main system or on a remote system may request position reports for one or more vehicles or objects. In another embodiment, subscriber television formats would enable a subscriber to request which vehicle to track during the race. Many television broadcasts allow for split screens, and picture-in-picture (PIP) displays, wherein the present accommodates a best implementation for viewer empowerment. While a service has been made available providing some telemetry data and driver view cameras, the present system augments the available information and produces a better/different result.

Although there may or may not be clients subscribing to the data feed associated with a particular tracked object, all objects that are transmitting position information are tracked at all times. The system contains multiple distinct modules that correspond to a series of processing steps. The earlier stages contain the processing of information from and the tracking of all targets. These modules calculate the absolute position of each target relative to the system's coordinate system.

The overall system computational and network load is reduced by only transmitting packets downstream of the Tracker 40 that have interested consumers. The time required for a client to switch from being interested in one target to being interested in another target is reduced since all targets are tracked all of the time. The verification of the system in the field is made easier since the various parts of the system can be tested and evaluated independently. And, functionally distinct components of the system can be run on physically distinct computers connected by a computer network. No requirement is imposed that the functional components that comprise the software system all be executed on a single computer system. Although computer processing power and network bandwidth seem to be increasing without limit it is still prudent to design a system to minimize the consumption of system resources. This allows for either additional functions to be added to the system or for the utilization of lower cost components. Some implementations of target tracking systems are so resource intensive that they choose to only actively track a small number of targets. This can lead to a delay when a new target is selected to be tracked. If a system is designed, as the current system is, so that all targets may be efficiently tracked at all times there is no delay upon target swap.

The ease with which a system can be setup in the field is a feature of any system. This is especially true of a system that by its nature will be a distributed one. The current system is designed as a set of pluggable modules. Each module can generally be run on its own or as part of the overall system. Each module also contains test logic that is used to verify the module's connection to other modules. This allows the integrity of the entire system to be verified.

Since the system is designed as a set of pluggable modules, it is easy to physically separate one or more modules on distinct hardware. This is another way that the system is made more scalable as multiple computers can be used if desired. Since all communication is done through computer network communications mechanisms, the various modules are unaware if they are on the same or separate systems. In one embodiment, the base station is mobile such as a van and includes the base station communications hardware and computer processing to provide a mobile target tracking service. The target position/communication sensors are small portable units and are attached or installed to the target during the required period and are removed from the target when tracking process is completed.

Targeting clients accept position reports and compute pointing strategies. Pointing strategies may be specific to each distinct type of client. This allows each type of client to optimize how the position reports are utilized based on functional needs of that client. These strategies can include constraints such as platform acceleration limits, quantitative tracking limits and smoothing. The strategies can optimize time on target as well as minimization of acceleration delta so as to present a smooth camera image.

One of the novel features of the present system is that it provides for distinct time systems for the GPS packet system and for the clients. GPS systems are by definition based on a fixed time system. GPS calculates position by performing calculations on the time required to receive a signal from each of the GPS satellites. A consequence of this is that each target will transmit a position on a time-based schedule. In one embodiment each target transmits a position report every 200 milliseconds. Depending upon the transmission system used the position reports may arrive at the Position Listener 30 in a variety of orders. For example, if a Time Division Multiplexer radio system is used, the packets would arrive in a round robin order based on the time division frequency of the radio. An important consequence of this is that the may be varying amounts of time elapsed between the processing of successive packets from the same target. This lack of deterministic timing does not present a problem for the Tracker 40 component that can continue its position processing with disparate inter-packet intervals.

At the same time, some clients may need to calculate a target relative bearing at periodic intervals, and these intervals may not correspond to the GPS packet frequency. Target Relative Bearings (TRB) need to be distinguished from absolute position reports. GPS packets describe a target's absolute position in the coordinate system. Some clients, however, also have a position. Examples would be sensors that are at fixed locations and named locations such as the start/finish line of a racecourse. Target relative bearings are angular deflections describing how an observer at a specified location should orient in order to observe the target. Clients must execute substantial algorithms to compute the TRB. Depending on the particular client this calculation may need to be performed on a specific time schedule. For example, a particular sensor's servo/gimbal may need to receive positioning commands several times a second in order to achieve smooth motion. The variety of clients supported by the system may mean that some clients require more TRB's per second than GPS packets while in other cases the client may require less TRB's per second. This means that the client requires a system to decouple the reception of GPS position reports from the use of position reports to calculate TRB's.

Each position report consists of the target's most recently received position along with ‘n’ predicted future positions. These future predicted positions consist of predicted location and the time when the target will be at that predicted location. The entries in the position report are in a time-increasing order. This creates a timeline of predicted positions for a specific target. The client system inserts this timeline into its own circular buffer that contains a timeline of predicted positions. The resolution of the client's timeline may be coarser or finer than the timeline of the GPS reporting system. The client's timeline is therefore said to be decoupled from the GPS reporting system's timeline. This allows each class of client to be implemented to a different set of constraints. In a typical implementation of the system, GPS position reports arrive every 200 milliseconds, while a particular client may require that predicted positions be calculated at 50 millisecond intervals. The actual platform positioning code can therefore select the most appropriate time based position to transmit to the tracking device.

Conversely, some sensors may not reside in fixed locations. Since a Speed Based Sensor 70 accepts position reports, it may request position reports for itself as well as for the target that it is tracking. Algorithms in the Speed Based Sensor 70 allow the TRB calculation to take place with a continually changing sensor position.

In operation of one embodiment, the target acquires positional information from a satellite as well as from a ground based position system in order to enhance the position information. The target relays that information to the multiplexer which forwards the position data to the client controllers for processing. Various satellite and ground based systems are permissible to extract the position information, and as satellite systems improve, the use of the additional ground based system may be redundant.

The invention is susceptible of many variations, all within the scope of the specification, figures, and claims. The preferred embodiment described here and illustrated in the figures should not be construed as in any way limiting. The objects and advantages of the invention may be further realized and attained by means of the instrumentalities and combinations particularly pointed out in the appended claims. Accordingly, the drawing and description are to be regarded as illustrative in nature, and not as restrictive

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for dynamically tracking and targeting at least one moving target, comprising:
a position location receiver located proximate said target, wherein said position location receiver receives present location information of said target;
a communicating apparatus coupled to said position location receiver;
at least one base station communicating with said target, wherein said communicating apparatus transmits said present location information to said base station, and wherein said base station calculates a projection location information; and
at least one autonomous client station coupled to said base station, wherein said client station acts upon said projection location information.

2. The system according to claim 1, wherein said communicating apparatus periodically emits said present location information.

3. The system according to claim 1, wherein said position location receiver obtains said present location information from a system selected from the group comprising: global positioning system (GPS), differential GPS, Ultra Wide Band (UWB), and Wide Area Augmentation System (WAAS) enhanced GPS.

4. The system according to claim 1, wherein said base stations receives, checks and processes present location information from multiple targets.

5. The system according to claim 1, further comprising a plurality of base stations receiving said present location information.

6. The system according to claim 1, wherein said projection location information is performed using Kalman filtering.

7. The system according to claim 6, with a real time input for modifying parameters of the Kalman filtering.

8. The system according to claim 1, wherein said base station simultaneously tracks each of said targets and said base station transmits said projection location to a client upon request.

9. The system according to claim 1, further comprising a publish/subscribe system wherein a subscriber requests a data feed from said client station.

10. The system according to claim 1, with a real time input for modifying parameters of said subscriber requests.

11. The system according to claim 1, wherein said client station is selected from the group comprising: a camera, a microphone, antenna, display, speaker, range finder, memory device, and a processing unit.

12. The system according to claim 1, wherein communication between said base station and said client station is bi-directional.

13. The system according to claim 1, further comprising a processor on said target and coupled to said position location receiver and said communications apparatus.

14. The system according to claim 1, wherein at least one of said targets is a client station.

15. A computer-implemented system for dynamically tracking and targeting multiple vehicles, comprising:
a plurality of targets containing a location receiver and a wireless communications apparatus;
at least one base station coupled to said targets, wherein said base station performs target processing to calculate projected target location; and
at least one client station coupled to said base station, wherein said client station directs a robotic pointing platform based on said target information.

16. The system according to claim 16, further comprising a calibration of said camera system.

17. The system according to claim 15, wherein said client station is an autonomous camera system receiving a set of positioning commands from said base station.

18. The system according to claim 15, further comprising a means to decouple the base station transmission rates from the client station service interval.

19. The system according to claim 15, further comprising a smoothing function for said robotic pointing platform.

20. The system according to claim 15, further comprising a publish/subscribe system wherein a subscriber requests a data feed from said client station.

21. The system according to claim 20, with a real time input for modifying parameters of said subscriber requests.

22. The system according to claim 15, wherein said robotic pointing platform tracks a synthesized target.
